(19) United States
(12) Patent Application Publication
(10) Pub. No.: US 2026/0147335 A1
(43) Pub. Date: May 28, 2026

(54) PROGRAMMING DEVICE, PROGRAMING METHOD, AND PROGRAM

(71) Applicant: FANUC CORPORATION, Yamanashi (JP)

(72) Inventor: Yuuki KIMOTO, Yamanashi (JP)

(73) Assignee: FANUC CORPORATION, Yamanashi (JP)

(21) Appl. No.: 19/120,973

(22) PCT Filed: Dec. 27, 2022
(86) PCT No.: PCT/JP2022/048307

§ 371 Date: Apr. 14, 2025

(51) Int. Cl. G05B 19/423; B25J 9/16

(52) U.S. Cl. CPC G05B 19/423; B25J 9/1664

(57) ABSTRACT

It is desired to further reduce the number of teaching points in a program that moves a robot. Provided is a programming device that generates trajectory information, which indicates a trajectory of movement of a tip point of a robot, as a program. The programming device comprises: a first trajectory information generation unit that generates first trajectory information indicating a trajectory of movement of the tip point of the robot, on the basis of a movement command for the robot; a teaching point generation unit that generates a teaching point on the trajectory of the first trajectory information; a program generation unit that generates a program of the first trajectory information in which the teaching point has been generated; a second trajectory information generation unit that acquires second trajectory information indicating a trajectory of movement of the tip point of the robot moved by the program; an error calculation unit that calculates an error between the first trajectory information and the second trajectory information; and a teaching point addition unit that adds a teaching point on the trajectory of the first trajectory information until the error becomes equal to or less than a tolerance value.

### TECHNICAL FIELD

The present disclosure pertains to a programming device, a programming method, and a program.

### BACKGROUND ART

Conventionally, a robot is controlled by an external control device instead of a dedicated control device (also referred to as “robot control device” below). In the case of using an external control device to control a robot, a movement command is sent at a short cycle to a robot control device from the external control device, whereby it is possible to control the robot. In such control of a robot, in addition to cases where the robot is controlled in real time by the external control device, there are cases where the movement of a robot, which is executed once through control by the external control device, is repeatedly performed through control by the robot control device. In this case, since it is necessary to save all movement commands that are sent at a short cycle from the external control device in the robot control device, the amount of data becomes enormous.

In order to solve such a problem, a method of saving has been proposed, which stores path information that indicates a movement path for a robot as a program. For example, Patent Document 1 describes a robot system that learns an error between an actual path and an ideal path that is controlled to pass through a specific intermediate teaching point and adds a teaching point to a position to achieve a target path, whereby the target path is realized.

### CITATION LIST

### Patent Document

Patent Document 1: PCT International Publication No. WO2022/176761

### DISCLOSURE OF THE INVENTION

### Problems to be Solved by the Invention

A movement command sent from an external control device has a large amount of data, and thus it is difficult to convert the movement command into a program. In addition, even if conversion to a program can be performed as in the aforementioned Patent Document 1, there is still the problem that the number of teaching points in the program will become enormous. In particular, the robot system in Patent Document 1 has the problem that prediction teaching is performed, and thus the calculation of intermediate points (teaching points) takes more time as a movement path becomes more complex.

Accordingly, reducing the number of teaching points in a program for causing a robot to move is desirable.

### Means for Solving the Problems

A programming device according to the present disclosure generates, as a program, path information that indicates a movement path for a tip point of a robot, the programming device being provided with: a first path information generation unit configured to, based on a movement command for the robot, generate first path information that indicates a movement path for the tip point of the robot; a teaching point generation unit configured to generate a teaching point on a path that corresponds to the first path information; a program generation unit configured to generate a program that corresponds to the first path information for which the teaching point is generated; a second path information generation unit configured to obtain second path information that indicates a movement path for the tip point of the robot that is caused to move in accordance with the program; an error calculation unit configured to calculate an error between the first path information and the second path information; and a teaching point addition unit configured to add a teaching point to the path that corresponds to the first path information until the error becomes equal to or less than a tolerance value.

A programming method according to the present disclosure generates, as a program, path information that indicates a movement path for a tip point of a robot, the programming method including: a step of generating, based on a movement command for the robot, first path information that indicates a movement path for the tip point of the robot; a step of generating a teaching point on a path that corresponds to the first path information; a step of generating a program that corresponds to the first path information for which the teaching point is generated; a step of obtaining second path information that indicates a movement path for the tip point of the robot that is caused to move in accordance with the program; a step of calculating an error between the first path information and the second path information; and a step of adding a teaching point to the path that corresponds to the first path information until the error becomes equal to or less than a tolerance value.

A program according to the present disclosure causes a Computer to execute a programming method that includes each step set forth in the above-described programming method.

### BRIEF DESCRIPTION OF THE DRAWINGS

FIG. 1 is a configuration diagram of a robot control system 1 according to one embodiment of the present disclosure;

FIG. 2 is a block diagram that illustrates a functional configuration of a robot control device 4;

FIG. 3 is a block diagram that illustrates a functional configuration of a programming unit 150;

FIG. 4A is a diagram that illustrates a process for generating teaching points for first path information;

FIG. 4B is a diagram that illustrates the process for generating teaching points for the first path information;

FIG. 4C is a diagram that illustrates the process for generating teaching points for the first path information;

FIG. 4D is a diagram that illustrates the process for generating teaching points for the first path information;

FIG. 4E is a diagram that illustrates the process for generating teaching points for the first path information;

FIG. 4F is a diagram that illustrates the process for generating teaching points for the first path information;

FIG. 4G is a diagram that illustrates the process for generating teaching points for the first path information;

FIG. 5A is a diagram that illustrates a process to bring second path information close to the first path information;

FIG. 5B is a diagram that illustrates the process to bring the second path information close to the first path information;

FIG. 5C is a diagram that illustrates the process to bring the second path information close to the first path information;

FIG. 6 is a flow chart that illustrates a procedure for a process for programming first path information, executed by the program management unit 15; and

FIG. 7 is a flow chart that illustrates the procedure for the process for programming first path information, executed by the program management unit 15.

### PREFERRED MODE FOR CARRYING OUT THE INVENTION

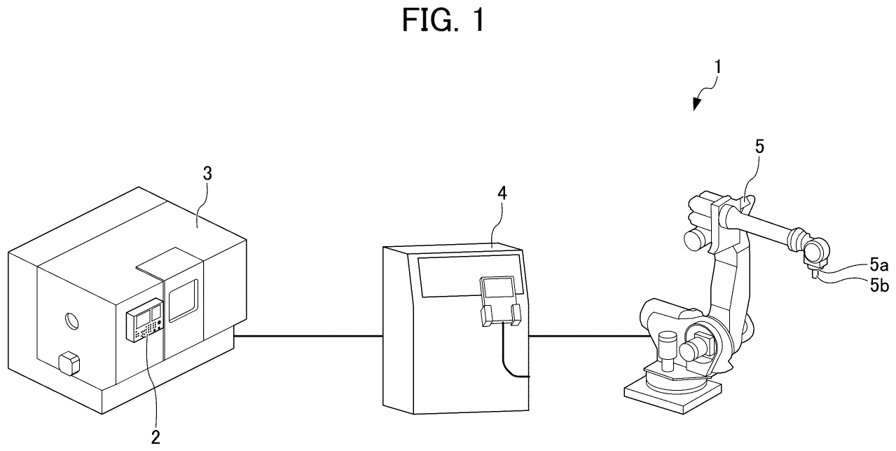

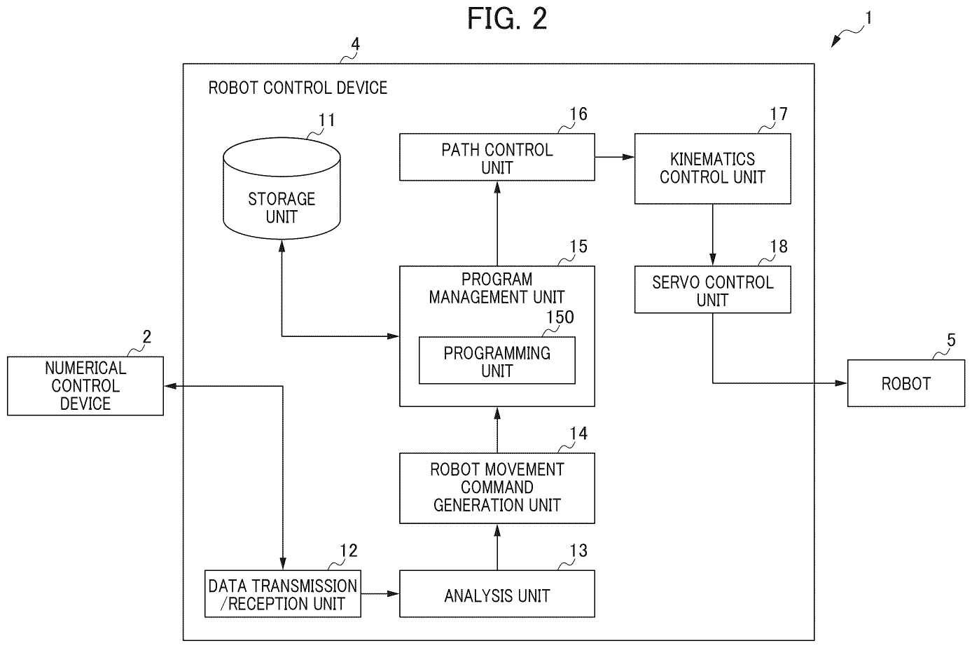

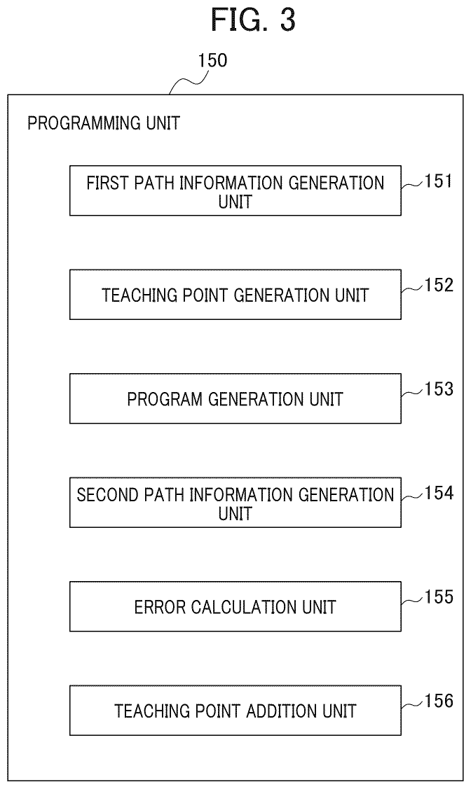

Description is given below regarding a programming device, a programming method, and a program according to one embodiment of the present disclosure. FIG. 1 is a configuration diagram of a robot control system 1 according to one embodiment of the present disclosure. FIG. 2 is a block diagram that illustrates a functional configuration of a robot control device 4. FIG. 3 is a block diagram that illustrates a functional configuration of a programming unit 150.

As illustrated in FIG. 1, the robot control system 1 according to the embodiment is provided with: a numerical control device 2, which controls a machine tool 3; the robot control device 4; and a robot 5. In the robot control system 1, the numerical control device 2, the robot control device 4, and the robot 5 are respectively connected via communication lines (solid black lines in the drawing).

In accordance with a numerical control program, the numerical control device 2 generates a machine tool command signal and a robot command signal as commands for the machine tool 3, and transmits the machine tool command signal and the robot command signal to the machine tool 3 and the robot 5, respectively. The numerical control device 2 according to the embodiment transmits the robot command signal at a short cycle (for example, 40 msec) to the robot control device 4, in a case of controlling the robot 5 in real time. The numerical control device 2 will serve as an external control device in a case of controlling the robot 5 via the robot control device 4. In other words, the numerical control device 2 is a control device (second control device) that differs from the robot control device 4 (described below), which directly controls a robot.

The machine tool 3 machines a workpiece (not shown) in response to the machine tool command signal transmitted from the numerical control device 2. The machine tool 3 is, for example, a lathe, a drill press, a milling machine, a grinding machine, a laser machining machine, an injection molding machine, or the like, but is not limited thereto.

The robot control device 4 is a control device (first control device) that directly controls movement of the robot 5. The robot control device 4 is connected communicably to the numerical control device 2, and controls the movement of the robot 5 in response to the robot command signal transmitted from the numerical control device 2. The configuration of the robot control device 4 will be described below.

The robot 5 is provided near the machine tool 3, and operates according to control performed by the robot control device 4. For example, the robot 5 executes a prescribed task for a workpiece that is machined within the machine tool 3 such as a lathe or the like. The robot 5 includes an articulated robot, for example. A tool 5b for grasping, machining, or inspecting a workpiece is attached to an arm tip 5a of the robot 5. In the embodiment, descriptions will be given regarding an example in which the robot 5 is assumed to be a six-axis articulated robot, but the number of axes for the joints of the robot 5 is not limited thereto.

The numerical control device 2 and the robot control device 4 are each, for example, a computer that employs, as hardware resources: an arithmetic processing means such as a CPU (Central Processing Unit); an auxiliary storage means such as an HDD (Hard Disk Drive) or SSD (Solid-State Drive) that stores various computer programs; a main storage means such as RAM (Random-Access Memory) for temporarily storing data in order for the arithmetic processing means to execute a computer program; an operation means such as a keyboard or mouse for an operator to execute input such as various instructions or information; and a display means such as a display device that displays various information. For example, the numerical control device 2 and the robot control device 4 are configured to transmit and receive various signals each other through a wired LAN.

Next, description is given regarding the configuration of the robot control device 4. As illustrated in FIG. 2, the robot control device 4 uses the hardware resources described above to realize various functions, such as a storage unit 11, a data transmission/reception unit 12, an analysis unit 13, a robot movement command generation unit 14, a program management unit 15, a path control unit 16, a kinematics control unit 17, and a servo control unit 18. Specifically, the robot control device 4 uses the storage unit 11, the data transmission/reception unit 12, the analysis unit 13, the robot movement command generation unit 14, the program management unit 15, the path control unit 16, the kinematics control unit 17, and the servo control unit 18 to thereby control movement of the robot 5, based on various command signals transmitted from the numerical control device 2.

The storage unit 11 stores, inter alia, various programs for causing a robot to operate, information that indicates positions of various shafts in the machine tool 3, information pertaining to a position or orientation of a control point for the robot, and information pertaining to teaching points for the robot. The data transmission/reception unit 12 receives a robot command signal that is transmitted from the numerical control device 2. In addition, the data transmission/reception unit 12 successively outputs the received robot command signal to the analysis unit 13. The analysis unit 13 analyzes the robot command signal, which is inputted from the data transmission/reception unit 12. In addition, the analysis unit 13 outputs a result of the analysis to the robot movement command generation unit 14.

Based on the result of analyzing the robot command signal input from the analysis unit 13, the robot movement command generation unit 14 generates a robot movement command (also referred to as a “movement command” below) that corresponds to this robot command signal. The robot movement command generation unit 14 outputs the generated movement command to the program management unit 15. Note that robot command signals are transmitted from the numerical control device 2 at a short cycle. Accordingly, in the robot movement command generation unit 14, the movement command is generated at the same cycle and outputted to the program management unit 15.

The robot movement command generation unit 14 inputs the movement command to the program management unit 15, whereby the program management unit 15 successively executes this movement command in real time. The program management unit 15 generates a movement plan for the robot 5 in response to the above-described movement command, and outputs the movement plan to the path control unit 16. As a result, it is possible to control the movement of the robot 5 in real time. In addition, for example, in a case of repeating a movement of the robot 5 that has been executed once, the program management unit 15 causes the robot 5 to move based on a program (described below) that corresponds to the first path information and is stored in the storage unit 11.

The program management unit 15 is provided with a programming unit (programming device) 150. Based on a robot command signal transmitted from the numerical control device 2, the programming unit 150 generates, as a program, path information that indicates a movement path for a tip point of the robot 5. In addition, in a case of causing the robot 5 to operate in accordance with the program generated by the programming unit 150, the program management unit 15 generates a movement plan based on path information that is for the robot and written in this program, and outputs the movement plan to the path control unit 16. Descriptions will be given in detail below regarding functionality of the programming unit 150.

The path control unit 16, upon being inputted with a movement plan from the program management unit 15, calculates time series data of control points for the robot 5, and outputs the time series data to the kinematics control unit 17. The kinematics control unit 17 calculates target angles for respective joints of the robot 5 from the inputted time series data, and outputs the target angles to the servo control unit 18.

The servo control unit 18 performs feedback control for respective servomotors in the robot 5 to generate robot control signals with respect to the robot 5 in order to realize the target angles inputted from the kinematics control unit 17, and inputs the robot control signals to the servomotors in the robot 5. As a result, the robot 5 moves in accordance with the movement plan generated by the program management unit 15.

Next, description is given regarding the programming unit 150. Based on a robot command signal transmitted from the numerical control device 2, the programming unit 150 generates, as a program, path information that indicates a movement path for a tip point of the robot 5, and causes the storage unit 11 to store the program. This program is used in a case where the robot control device 4 controls the robot 5 directly instead of the numerical control device 2. In the embodiment, the tip point of the robot 5 is the arm tip 5a of the robot 5, for example (refer to FIG. 1).

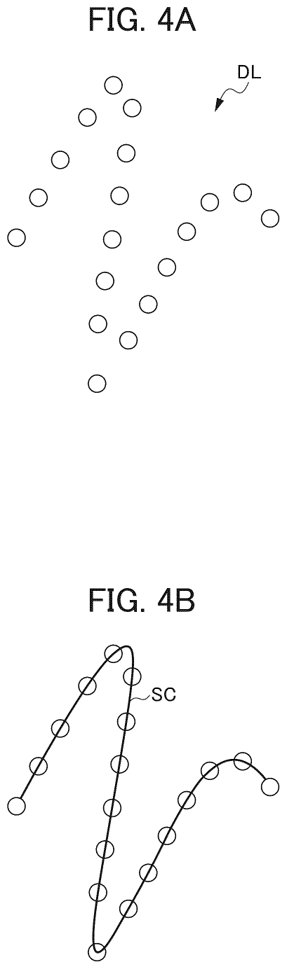

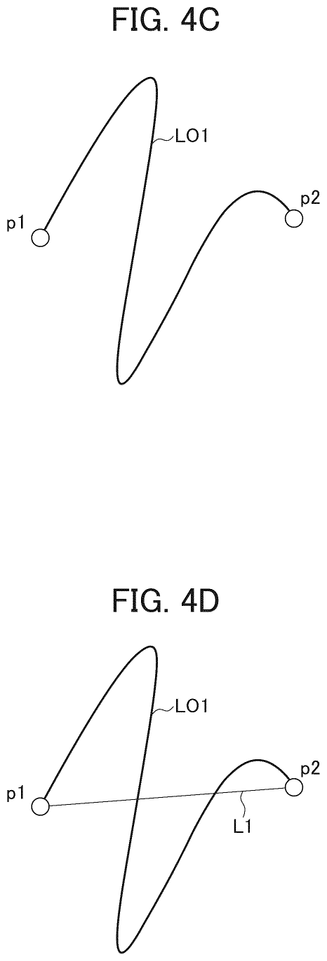

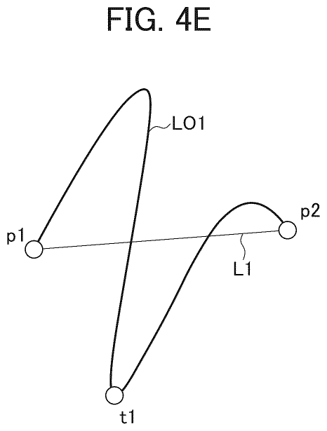

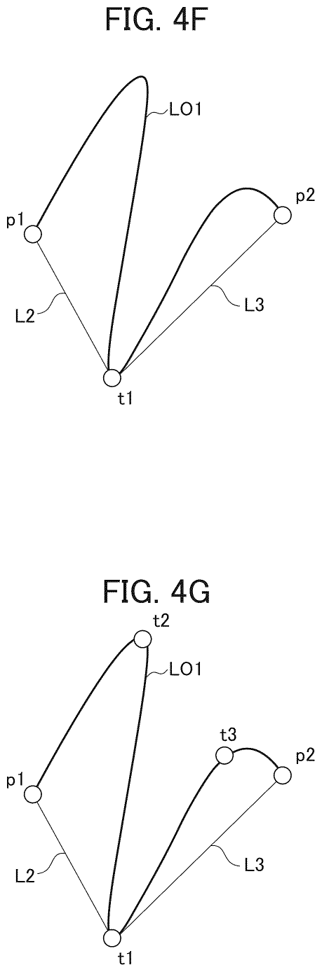

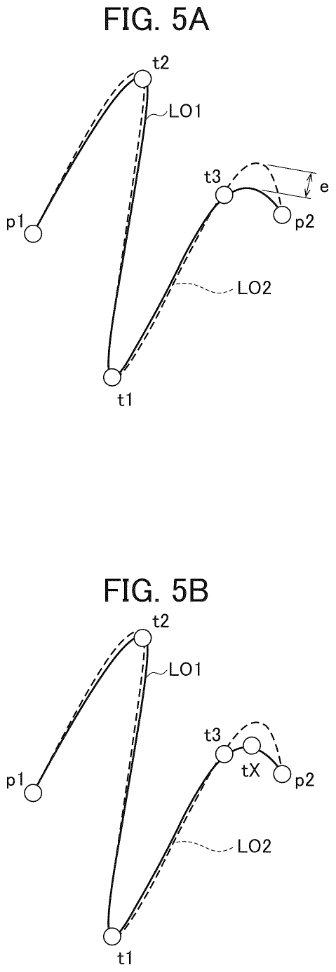

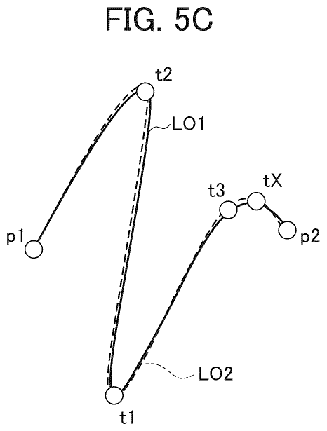

As illustrated in FIG. 3, the programming unit 150 is provided with a first path information generation unit 151, a teaching point generation unit 152, a program generation unit 153, a second path information generation unit 154, an error calculation unit 155, and a teaching point addition unit 156. Descriptions will be given below regarding processes executed by each unit included in the programming unit 150 and concrete examples thereof with reference to drawings. FIG. 4A through FIG. 4G are diagrams that illustrate a process for generating teaching points for first path information. FIG. 5A through FIG. 5C are diagrams that illustrate a process to bring the second path information close to the first path information. A process or the like that generates a virtual straight line or generates a teaching point with respect to path information is, for example, executed in a virtual space in the storage unit 11.

The first path information generation unit 151 records a movement command, which is generated by the robot movement command generation unit 14, until the movement of the robot 5 ends. Based on the stored movement command for the robot 5, the first path information generation unit 151 then generates three-dimensional first path information that indicates a movement path (including an orientation) for the tip point of the robot 5. Specifically, based on the stored movement command, the first path information generation unit 151 obtains a path (a sequence of points) DL that is for the tip point of the robot 5 per amount of time, as illustrated in FIG. 4A. In FIG. 4A, a size of a point and an interval between adjacent points are schematically drawn in order to facilitate understanding.

In addition, three-dimensional path information (first path information and second path information) is described as a two-dimensional curved line in the embodiment. An orientation of the tip point of the robot 5, which is, for example, defined in accordance with a rotation angle of the shaft that drives the arm tip 5a of the robot 5 (refer to FIG. 1), continuously changes from the start point to the end point of the movement path.

The first path information generation unit 151 generates a spline curved line (spline function) SC that passes through the obtained path, as illustrated in FIG. 4B. The curved line that indicates the movement path of the tip point of the robot as illustrated in FIG. 4B may hereinafter also be referred to as “first path information” or “first path information LO1”. Note that a movement path may include a straight-line portion as well as a curved-line portion, but is referred to generically as a “curved line” in the present specification.

The teaching point generation unit 152 generates teaching points on a path that corresponds to the first path information. Specifically, the teaching point generation unit 152 sets a start point p1 and an end point p2 on the first path information LO1 as illustrated in FIG. 4C, and also virtually generates a straight line I1 between the start point p1 and the end point p2 as illustrated in FIG. 4D. The teaching point generation unit 152 then determines whether there is a point whose distance from the straight line L1 is both the farthest and equal to or greater than a threshold. In a case where there is a corresponding point, the teaching point generation unit 152 generates a teaching point t1 at this point, as illustrated in FIG. 4E. The distance threshold based on which the determination described above is performed is, for example, set by an operator making an input via an operation means (not shown).

In a case where a teaching point is generated with respect to the first path information (in a case where a teaching point is established), the teaching point generation unit 152 further generates a straight line L2 virtually between the start point p1 and the teaching point t1, and also a straight line L3 virtually between the teaching point t1 and the end point p2, as illustrated in FIG. 4F. The teaching point generation unit 152 determines whether there is a point whose distance from each straight line is the farthest and equal to or greater than the threshold, and, in a case where there is a corresponding point, generates a teaching point at the corresponding point. FIG. 4G illustrates an example in which a teaching point t2 is generated at a point where the distance from the straight line 12 is the farthest and equal to or greater than the threshold, and a teaching point t3 is generated at a point where the distance from the straight line L3 is the farthest and equal to or greater than the threshold. The teaching point generation unit 152 repeats the above-described process until there is no point whose distance from the straight line is equal to or greater than the threshold.

In a case where two or more teaching points are generated between the start point and the end point as illustrated in FIG. 4G, the teaching point generation unit 152 virtually generates not only a straight line between either the start point or the end point and a teaching point that is adjacent thereto but also a straight line between a teaching point and another teaching point which are adjacent to each other on a curved line. In the case where there is no point whose distance from the straight line is the farthest and equal to or greater than the threshold (in a case where a teaching point is not established), the teaching point generation unit 152 ends the process for generating teaching points.

In the example illustrated in FIG. 4G, the teaching point generation unit 152 generates virtual straight lines (not shown) between the start point p1 and the teaching point t2, between the teaching points t2 and t1, between the teaching points t1 and t3, and between the teaching point t3 and the end point p2, respectively; and determines whether there is a point whose distance from each of the straight lines is the farthest and equal to or greater than a threshold. In the example illustrated in FIG. 4G, it is assumed that a new teaching point was not established in the determination based on the above-described straight lines generated for the first path information. In the embodiment, the curved line illustrated in FIG. 4G becomes initial first path information for which teaching points are generated.

Returning to FIG. 3, the program generation unit 153 generates a program that corresponds to the first path information in which teaching points are generated or added to, or generates a program that corresponds to the first path information whose distance error is equal to or less than a tolerance value. The program generation unit 153 uses a movement command which instructs the tip point of the robot 5 to pass through the positions of the teaching points to generate a program for the first path information. The movement command which instructs the tip point of the robot 5 to pass through the positions of the teaching points includes a program which causes the tip point to pass through the positions of all the teaching points on the path, and, for example, a spline interpolation movement command may be used.

The program management unit 15 causes the robot 5 to operate based on the program that corresponds to the first path information and is generated by the program generation unit 153. Note that the movement plan generated by the program management unit 15 is outputted to the path control unit 16 and accordingly the movement of the robot 5 is executed via the kinematics control unit 17 and the servo control unit 18. In the program generation unit 153, a process for generating the program that corresponds to the first path information and has teaching points on the path thereof is repeatedly executed each time a teaching point is added by the teaching point addition unit 156 (described below).

In the program management unit 15, the second path information generation unit 154 obtains second path information that indicates a movement path for the tip point of the robot 5, which is caused to move in accordance with the program that corresponds to the first path information. In the second path information generation unit 154, a process for obtaining the second path information is repeatedly executed each time a teaching point is added to the first path information by the teaching point addition unit 156 (to be described below).

The error calculation unit 155 calculates an error between the first path information and the second path information. FIG. 5A is a diagram in which a curved line for the second path information is overlapped on the curved line for the first path information. In FIG. 5A, a solid line indicates the curved line for the first path information LO1. A broken line indicates the curved line for second path information LO2, in a case where the robot 5 is actually caused to move. For example, the error calculation unit 155 calculates an error e between the first path information LO1 and the second path information LO2 in an interval between the teaching point t3 and the end point p2 illustrated in FIG. 5A. In addition, errors between the first path information LO1 and the second path information LO2 are calculated in intervals between the start point p1 and the teaching point t2, between the teaching points t2 and t1, and between the teaching points t1 and t3.

The error calculated in the error calculation unit 155 includes an orientation error as well as a distance error between two curved lines. The orientation error is an error in a three-dimensional coordinate space for two curved lines. As illustrated in a later-described flow chart (Step S19 and thereafter), if a distance error between two curved lines has become equal to or less than a tolerance value, the error calculation unit 155 calculates an orientation error between the two curved lines.

For example, it is possible to use a method such as the following to calculate an error in the error calculation unit 155. Firstly, curved lines for two pieces of path information are each projected onto an X plane to acquire two-dimensional (X-Y) curved lines. By comparing two two-dimensional curved lines, a difference in a 2 axis value and a difference in a wrp angle are compared with respect to a specific Y axis value. Such a process is also executed for a Y plane and Z plane in addition to the X plane. In addition, it may be possible to: divide a curved line at the position of a teaching point; calculate a straight line connecting a start point and an end point of the divided curved line and a plane in which a point farthest from the straight line exists; and calculate an error between curved lines for two pieces of path information with respect to the plane. In addition, it may also be possible to set points that divide each curved line into designated equal portions on curved lines for two pieces of path information, and calculate a distance between a pair of corresponding points on the two curved lines as an error between the curved lines.

The teaching point addition unit 156 determines whether the distance or orientation error calculated by the error calculation unit 155 is equal to or less than a tolerance value. A tolerance value for the distance or orientation error is inputted in advance to the program management unit 15 by an operator. In a case where there is an interval for which the distance or orientation error exceeds the tolerance value, for example, in a case where the distance error exceeds the tolerance value in an interval between the teaching point t3 and the end point p2 of the first path information L01 illustrated in FIG. 5B, the teaching point addition unit 156 adds a teaching point tx to the point (position) at which the error e is greatest. A teaching point is also added to other intervals in a case where the distance error e exceeds the tolerance value. The teaching point addition unit 156 adds a teaching point to at least one position in the sequence of points (refer to FIG. 4A) that serves as the basis for the first path information. Although illustration is not given, the teaching point addition unit 156 adds a teaching point to a point having the greatest orientation error in the first path information LO1. After a teaching point is added by the teaching point addition unit 156, the program generation unit 153 generates a program that corresponds to the first path information to which the teaching point has been added.

The teaching point addition unit 156 repeats a process for adding a teaching point to the path that corresponds to the first path information, until the distance or orientation error becomes equal to or less than the tolerance value. In the teaching point addition unit 156, the distance or orientation error decreases each time a teaching point is added. As a result, it is possible to bring the second path information close to the first path information. In contrast, in a case where it is determined that the distance or orientation error is less than or equal to the tolerance value by the teaching point addition unit 156, as will be described below, the program that corresponds to the first path information is stored in the storage unit 11 as a program that corresponds to the path information that indicates a movement path for the tip point of the robot 5.

As described earlier, the program generation unit 153 generates a program that corresponds to the first path information to which a teaching point has been added by the teaching point addition unit 156. The program management unit 15 causes the robot 5 to move based on the program that corresponds to the first path information and has been newly generated by the program generation unit 153. The second path information generation unit 154 obtains second path information that indicates a movement path for the tip point of the robot 5, which is caused to move in accordance with the newly created program that corresponds to the first path information. Note that, in a case where the robot 5 is caused to move based on the program that corresponds to the first path information to which a teaching point has been added, the entirety of the curved line for the second path information may change, in addition to the portion to which the teaching point has been added. The error calculation unit 155 calculates the distance or orientation error between the first path information and the second path information. The teaching point addition unit 156 determines whether the distance or orientation error is equal to or less than the tolerance value.

The programming unit 150 repeats a process for adding a teaching point to the aforementioned path that corresponds to the first path information, until the distance or orientation error is determined to be equal to or less than the tolerance value by the teaching point addition unit 156. As a result, for example, the distance or orientation error between the first path information LO1 and the second path information LO2 can be kept equal to or less than the tolerance value in each interval, as illustrated in FIG. 5C. The program management unit 15 stores the program that corresponds to the first path information illustrated in FIG. 5C to the storage unit 11 as a program that corresponds to path information that indicates a movement path for the tip point of the robot 5.

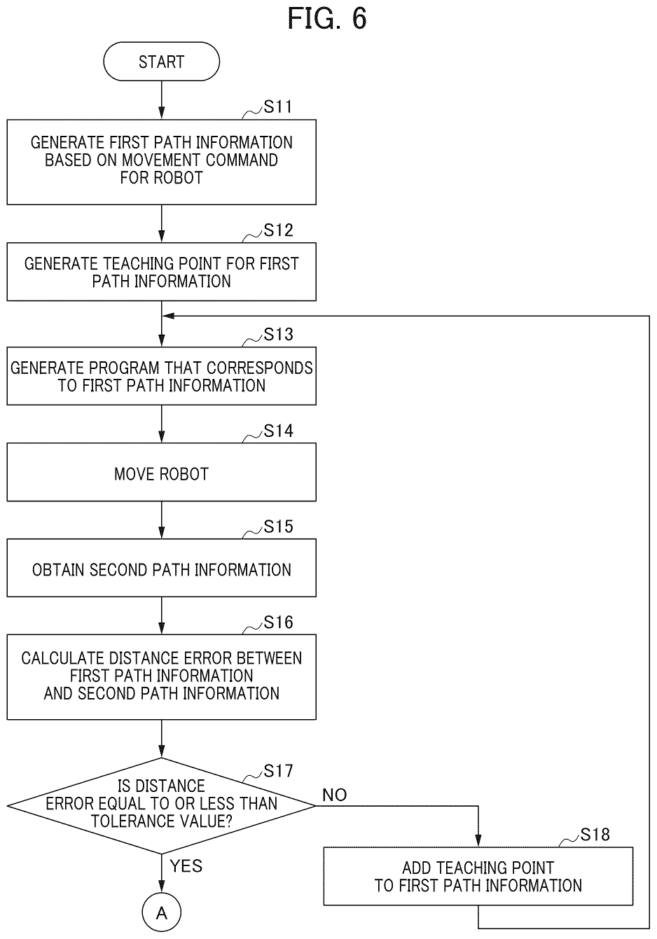

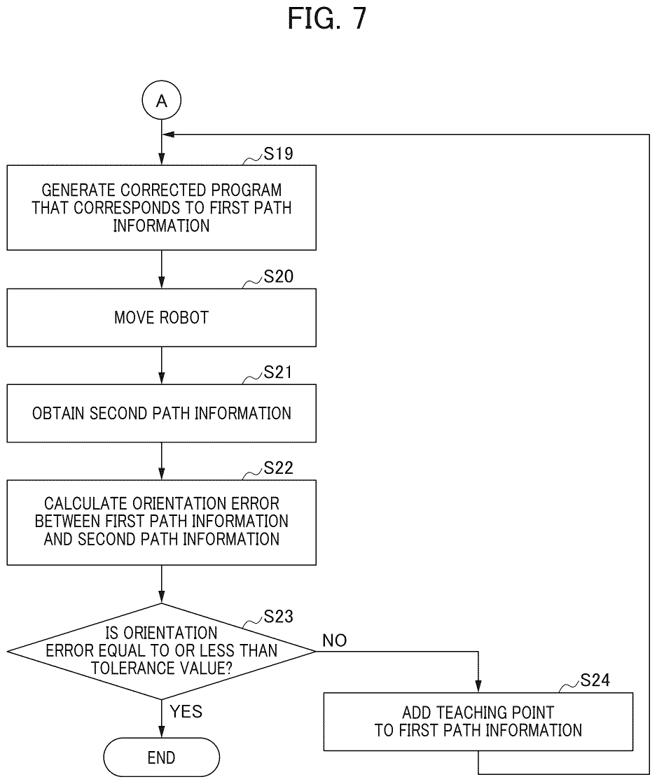

Next, descriptions will be given regarding a concrete example of a programming process for the first path information in the embodiment. FIG. 6 and FIG. 7 are flow charts that illustrate a procedure for a process for programming first path information, executed by the program management unit 15. Note that, before this programming process in the embodiment, the program management unit 15 generates a movement command based on a robot command signal transmitted from the numerical control device 2, and uses this movement Command to cause the robot 5 to move.

In Step S11 illustrated in FIG. 6, the first path information generation unit 151 records a movement command, which is generated by the robot movement command generation unit 14, until the movement of the robot 5 ends. Based on the movement command for the robot 5, the first path information generation unit 151 then generates first path information that indicates a movement path for the tip point of the robot 5.

In Step S12, the teaching point generation unit 152, based on the threshold, generates a teaching point on the path that corresponds to the first path information.

In Step S13, the program generation unit 153 generates a program that corresponds to the first path information in which a teaching point has been generated or added to.

In Step S14, the program management unit 15 causes the robot 5 to move based on the program that corresponds to the first path information.

In Step S15, the second path information generation unit 154 obtains second path information that indicates a movement path for the tip point of the robot 5, which is caused to move in accordance with the program that corresponds to the first path information.

In Step S16, the error calculation unit 155 calculates a distance error between the first path information and the second path information.

In Step S17, the teaching point addition unit 156 determines whether the distance error is equal to or less than a tolerance value. In a case where the teaching point addition unit 156 determines in Step S17 that the distance error is equal to or less than the tolerance value, the process proceeds to Step S19 (refer to FIG. 7). In contrast, in a case where the teaching point addition unit 156 has determined in Step S17 that the distance error exceeds the tolerance value, the process proceeds to Step S18.

In Step S18 (Step S17: NO), the teaching point addition unit 156 adds a teaching point to the first path information.

The process returns to Step S13 after Step S18, and processing for Step S13 through Step S17 described above is performed, based on the first path information to which the teaching point has been added. The teaching point addition unit 156 repeatedly executes the process for adding a teaching point to the path that corresponds to the first path information, until the distance error becomes equal to or less than the tolerance value in Step S17.

In Step S19 (Step S17: YES) illustrated in FIG. 7, the program generation unit 153 generates a program that Corresponds to the first path information whose distance error has become equal to or less than the tolerance value (may be referred to as the “corrected program” below).

In Step S20, the program management unit 15 causes the robot 5 to move based on the corrected program that corresponds to the first path information.

In Step S21, the second path information generation unit 154 obtains second path information that indicates a movement. path for the tip point of the robot 5, which has been caused to move in accordance with the corrected program that corresponds to the first path information.

In Step S22, the error calculation unit 155 calculates an orientation error between the first path information whose distance error has become equal to or less than the tolerance value and the second path information obtained in Step S21.

In Step S23, the teaching point addition unit 156 determines whether the orientation error is equal to or less than a tolerance value. In a case where the teaching point addition unit 156 determines in Step S23 that the orientation error is equal to or less than the tolerance value, the process for the present flow chart ends. In contrast, in a case where the teaching point addition unit 156 determines in Step S23 that the orientation error exceeds the tolerance value, the process proceeds to Step S24.

In Step S24 (Step S23: NO), the teaching point addition unit 156 adds a teaching point to the first path information.

The process returns to Step S19 after Step S24. Subsequently, processing for Step S20 through Step S23 described above is performed, based on the first path information to which the teaching point has been added. The teaching point addition unit 156 repeatedly executes the process for adding a teaching point to the path that corresponds to the first path information, until the orientation error becomes equal to or less than the tolerance value in Step S23. In a case where it is determined in Step S23 that the orientation error is equal to or less than the tolerance value, the process for the present flow chart ends.

By virtue of the robot control device 4 according to the embodiment described above, for example, the following effects are achieved. The robot control device 4 is provided with the programming unit 150 that: compares the first path information generated based on the movement command from the external numerical control device 2 with the second path information that will serve as the movement path for the robot that is caused to move in accordance with the program that corresponds to the first path information; and adds the teaching point to the first path information until both distance error and orientation error become equal to or less than the tolerance value. As a result, the robot control device 4 is able to generate, as a program that has few teaching points, the program that corresponds to the first path information and has the same movement path (including the orientation) as that of the robot which is controlled in real time in accordance with the movement command from the numerical control device 2.

The program generation unit 153 uses the movement command which instructs the tip point of the robot to passe through the positions of the teaching points to generate the program that corresponds to the first path information, As a result, it will be unnecessary to learn an error in advance by a preparation in which a robot is controlled after setting a target path that employs a point not on an ideal path as an intermediate point, as described in Patent Document 1. Accordingly, in a case where the route for a movement path for a robot is complex, there is no need to perform a huge amount of learning work in advance, and thus it is possible to generate a program for the robot in a shorter amount of time.

The first path information generated in the first path information generation unit 151 is formed of the sequence of points that indicate the positions of the tip point of the robot. Accordingly, in a case where the program that corresponds to the first path information generated by the program generation unit 153 is executed, it is possible to more faithfully reproduce movement than in a case where the robot is controlled by the numerical control device 2.

The teaching point addition unit 156 adds the teaching point to at least one position in the sequence of points (refer to FIG. 4A) that serve as the basis for the first path information. Accordingly, it is possible to bring the path, in which the robot is actually caused to move, close to the path that corresponds to the first path information by a smaller number of teaching points, in comparison to a case of adding a teaching point to a position that lies apart from a curved line as described in Patent Document 1.

The program generation unit 153 generates the program that corresponds to the first path information, based on the teaching points generated on the path that corresponds to the first path information. Accordingly, in the program generation unit 153, the method such as spline interpolation is applied to the teaching points on the path in the program generation unit 153, whereby it is possible to generate the program for reproducing the movement that is closer to the actual movement by the robot.

The first path information generation unit 151 obtains the movement command for the robot 5 from the numerical control device 2 (second control device) that differs from the robot control device 4 (first control device), which directly controls the robot. Accordingly, when it is desired to repeatedly perform the movement of the robot that has been executed once, the robot control device 4 can cause the robot to move similarly with the robot which is controlled in real time.

### Modification

Description is given above regarding an embodiment of the present disclosure, but the present disclosure is not limited to the embodiment described above. These embodiments can be subjected to various additions, replacements, changes, partial deletions, or the like within a scope that does not deviate from the substance of the present disclosure or within a scope that does not deviate from the purport of the present disclosure derived from the content set forth in the claims or equivalents thereto, In addition, these embodiments can be worked in combination. For example, the order of operations or the order of processes in the embodiments described above is indicated as an example, and there is no limitation thereto.

In the embodiment according to the present disclosure, all hardware resources for the robot control device 4 may be disposed in the same housing, or may be disposed separately in a plurality of housings.

In the embodiment according to the present disclosure, the description has been given regarding an example in which one robot control device 4 is connected to one numerical control device 2, but there is no limitation thereto. It may be alternatively possible that a plurality of robot control devices 4 are connected to one or more numerical control devices 2.

In relation to the embodiments and variations described above, the following notes are also disclosed.

### Note 1

A programming device (150) that generates, as a program, path information that indicates a movement path for a tip point of a robot, the programming device includes: a first path information generation unit (151) configured to, based on a movement command for the robot, generate first path information that indicates a movement path for the tip point of the robot; a teaching point generation unit (152) configured to generate a teaching point on a path that corresponds to the first path information; a program generation unit (153) configured to generate a program that corresponds to the first path information for which the teaching point is generated; a second path information generation unit (154) configured to obtain second path information that indicates a movement path for the tip point of the robot that is caused to move in accordance with the program; an error calculation unit (155) configured to calculate an error between the first path information and the second path information; and a teaching point addition unit (156) configured to add a teaching point to the path that Corresponds to the first path information until the error becomes equal to or less than a tolerance value.

### Note 2

The program generation unit (153) generates the program that corresponds to the first path information by using a movement command which instructs the tip point of the robot to pass through a position corresponding to the teaching point.

### Note 3

The first path information is configured to be a sequence of points that indicate positions of the tip point of the robot.

### Note 4

The teaching point addition unit (156) is configured to add a teaching point to at least one position in the sequence of points.

### Note 5

The program generation unit (153) is configured to generate the program that corresponds to the first path information, based on a teaching point generated on the path that corresponds to the first path information.

### Note 6

The first path information generation unit (151) is configured to obtain the movement command for the robot from a second control device (2) that differs from a first control device (4) that directly controls the robot.

### Note 7

A programming method that generates, as a program, path information that indicates a movement path for a tip point of a robot, the programming method includes: a step of generating, based on a movement command for the robot, first path information that indicates a movement path for the tip point of the robot; a step of generating a teaching point on a path that corresponds to the first path information; a step of generating a program that corresponds to the first path information for which the teaching point is generated; a step of obtaining second path information that indicates a movement path for the tip point of the robot that is caused to move in accordance with the program; a step of calculating an error between the first path information and the second path information; and a step of adding a teaching point to the path that corresponds to the first path information until the error becomes equal to or less than a tolerance value.

### Note 8

A program causes a computer to execute a programming method that includes each step set forth in the above-described programming method.

### EXPLANATION OF REFERENCE NUMERALS

1: Robot control system, 2: Numerical control device, 3: Machine tool, 4: Robot control device, 5: Robot, 5a: Arm tip, 11: Storage unit, 12: Data transmission/reception unit, 13: Analysis unit, 14: Robot movement command generation unit, 15: Program management unit, 16: Path control unit, 17: Kinematics control unit, 18: Servo control unit, 51: First path information generation unit, 150: Programming unit, 151: First path information generation unit, 152: Teaching point generation unit, 153: Program generation unit, 154: Second path information generation unit, 155: Error calculation unit, 156: Teaching point addition unit

1. A programming device for generating, as a program, path information that indicates a movement path for a tip point of a robot, the programming device comprising:
a first path information generation unit configured to, based on a movement command for the robot, generate first path information that indicates a movement path for the tip point of the robot;
a teaching point generation unit configured to generate a teaching point on a path that corresponds to the first path information;
a program generation unit configured to generate a program that corresponds to the first path information for which the teaching point is generated;
a second path information generation unit configured to obtain second path information that indicates a movement path for the tip point of the robot that is caused to move in accordance with the program;
an error calculation unit configured to calculate an error between the first path information and the second path information; and
a teaching point addition unit configured to add a teaching point to the path that corresponds to the first path information until the error becomes equal to or less than a tolerance value.

2. The programming device according to claim 1, wherein
the program generation unit configured to generate the program that corresponds to the first path information by using a movement command which instructs the tip point of the robot to pass through a position corresponding to the teaching point.

3. The programming device according to claim wherein
the first path information is configured to be a sequence of points that indicate positions of the tip point of the robot.

4. The programming device according to claim 3, wherein
the teaching point addition unit configured to add a teaching point to at least one position in the sequence of points.

5. The programming device according to claim 1, wherein
the program generation unit configured to generate the program that corresponds to the first path information, based on a teaching point generated on the path that corresponds to the first path information.

6. The programming device according to claim 1, wherein
the first path information generation unit configured to obtain the movement command for the robot from a second control device that differs from a first control device that directly controls the robot.

7. A programming method for generating, as a program, path information that indicates a movement path for a tip point of a robot, the programming method comprising:
a step of generating, based on a movement command for the robot, first path information that indicates a movement path for the tip point of the robot;
a step of generating a teaching point on a path that corresponds to the first path information;
a step of generating a program that corresponds to the first path information for which the teaching point is generated;
a step of obtaining second path information that indicates a movement path for the tip point of the robot that is caused to move in accordance with the program;
a step of calculating an error between the first path information and the second path information; and
a step of adding a teaching point to the path that corresponds to the first path information until the error becomes equal to or less than a tolerance value.

8. A non-transitory computer-readable storage medium storing a program for causing a computer to execute a programming method that includes each step set forth in claim 7.
